(19) United States
(12) Patent Application Publication
(10) Pub. No.: US 2013/0020984 A1
(43) Pub. Date: Jan. 24, 2013

(54) Battery Charging Cable Storage and Carry Kit for Electric Vehicle

(71) Applicants: Marc Jonathon Lucas, Remagen- Oberwinter (DE); John Hart, Clinton Township, MI (US)

(72) Inventors: Marc Jonathon Lucas, Remagen- Oberwinter (DE); John Hart, Clinton Township, MI (US)

(73) Assignee: FORD GLOBAL TECHNOLOGIES, LLC, Dearborn, MI (US)

(21) Appl. No.: 13/185,586

(22) Filed: Jul. 19, 2011

(51) Int. Cl. H02J 7/00; B65D 33/02

(52) U.S. Cl. 320/107; 383/33

(57) ABSTRACT

A battery charging kit for an automotive vehicle includes a charging cable, a mounting bracket attached to a structure within an interior of the vehicle, and a carry bag for containing the cable. The bag has first and second flexible/foldable side walls and stiffeners extend along opposite upper edges of the sidewalls to define an upper opening. Carry handles are attached to the stiffeners. The stiffeners includes engagement features removably attachable to the mounting bracket to retain the carry bag such that the side walls hang downwardly and the upper opening is open, the opening being sufficiently large to receive a battery charging cable. Multiple mounting brackets may be provided at different locations in the passenger compartment and/or cargo compartment and/or trunk so that the vehicle operator can select from among them.

### TECHNICAL FIELD

The invention relates to a system for stowing and carrying a recharging cable for use with “plug-in” rechargeable electrified vehicles.

### BACKGROUND

Some types of electrically powered vehicles such as plug-in hybrids and battery electric vehicles use a charging cable to connect the vehicle to an off-board source of electric power when it is necessary to charge/re-charge the on-board batteries. It may be desirable to store the charging cable on board the vehicle and, if this is the case, it is desirable to ensure that the vehicle operator has secure storage and easy access to the cable when needed. If the charging cable is stored loose in the passenger compartment, trunk or other cargo compartment of the vehicle, there is a risk that it may become a hazard during a collision. Also, it may be difficult to find when needed, particularly if there are other objects in the trunk or cargo compartment that may be hiding or blocking access to the cable. If the charging cable is stored in a compartment within the vehicle trunk or cargo area, access to the compartment may be blocked by other objects and so require removal of those other objects in order to reach the charging cable.

Storing the charging cable in the passenger compartment is generally the most convenient, since it may be accessed without the need to open a trunk lid or hatch. A possible down-side to storage in the passenger compartment is that the cable may be wet and/or dirty from use outside the vehicle. Also, the cable may need to be coiled, tied, wrapped around a spool, or otherwise secured so that it has a tidy appearance, does not become knotted, and may be handled easily.

### SUMMARY

In one disclosed embodiment of the invention, a battery charging kit for an automotive vehicle comprises a charging cable, a mounting bracket attachable to a structure within an interior of the vehicle, and a carry bag comprising at least one flexible panel and at least one rigid component attached to the flexible panel adjacent an upper opening of the bag. The rigid component comprises at least one engagement feature removably attachable to the mounting bracket to retain the carry bag such that the at least one flexible panel hangs downwardly from the at least one rigid component and the upper opening is in an open condition. The mounting bracket may be mounted at many different locations within the vehicle to provide maximum convenience for the vehicle operator.

In another embodiment of the invention, a battery charging kit for an automotive vehicle comprises a carry bag having first and second flexible side walls, a first stiffener extending along an upper edge of the first sidewall, a second stiffener extending along an upper edge of the second sidewall, and at least one carry handle. The kit further comprises a mounting bracket securable at a location within an interior of the vehicle and comprising a first retention point for removably receiving the first stiffener and a second retention point for removably receiving the second stiffener. The first and second retention points are spaced apart from one another by a distance such that the first and second stiffeners, when engaged with their respective retention points, are spaced apart from one another to define opposite edges of an opening of the carry bag, the opening being sufficiently large to receive a battery charging cable.

In another embodiment of the invention, an automotive vehicle comprises a first mounting bracket secured at a first location within the vehicle interior, a second mounting bracket secured at a second location within the interior, and a cable carry bag. The carry bag comprises at least one engagement feature alternatively engageable with either of the first and the second mounting brackets to secure the carry bag in a removable relationship with the vehicle at either of the first and the second locations. The carry bag further comprises a handle adapted for grasping by a human hand in order to carry the bag.

### BRIEF DESCRIPTION OF THE DRAWINGS

Embodiments of the present invention will now be described by way of example only. With reference to accompanying drawings in which:

FIG. 2 is a partial cross-sectional view of the carry bag and mounting bracket of FIG. 1 when engaged with one another;

FIG. 3 is a schematic diagram of an alternative embodiment of a mounting bracket;

FIG. 4 is a schematic diagram of a cable wrap unit for use with a carry and storage bag;

FIG. 5 is a schematic diagram of a vehicle passenger compartment showing alternative locations of a mounting brackets; and

FIG. 6 is a schematic diagram of a trunk area of a vehicle showing alternative mounting locations for a mounting bracket.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

Referring to FIG. 1, an embodiment of an electric charging cable storage and carry kit includes a carry bag 10 and a mounting bracket 12. Mounting bracket 12 is adapted to be secured at one or more locations within the interior of the vehicle. Carry bag 10 is configured to contain a charging cable 13 and is removably engageable with mounting bracket 12 so that the bag may be easily inserted to engagement with the mounting bracket to secure the carry bag in a desired location in the vehicle, and may be easily removed from engagement with the mounting bracket so that the carry bag can be removed from the vehicle and carried by a vehicle operator.

Carry bag 10 comprises a cable compartment 14, upper stiffeners 16, carry handles 18, and engagement features 20. Cable compartment 14 may be formed of flexible and/or foldable material, such as a woven or non-woven sheet or sheets of fabric or plastic. Upper stiffeners 16 extend along opposite upper edges of a bag opening formed by cable compartment 14 and may advantageously be formed of a rigid plastic material such as PVC or lightweight metal.

In the embodiment depicted, carry handles 18 are attached to or integrated with upper stiffeners 16 and are sized and configured so that a human hand can easily grasp either of the handles. Engagement features 20 extend from the respective upper stiffeners 16 and may be rigidly secured to the stiffeners and/or formed integrally with the stiffeners.

Mounting bracket 12 may be formed of a metal, plastic, or other appropriate rigid material or combination of materials and may be attached to vehicle interior structure using mounting holes 22 and associated fasteners (not shown). Alternatively, mounting bracket 12 may be secured to vehicle structure by adhesive or any other appropriate means. Mounting bracket 12 comprises first and second receptacles 24 configured to receive respective engagement features 20. Receptacles 24 serve as retention points for removably engaging the engagement features 20. In the embodiment shown, receptacles 24 comprise upwardly opening slots into which engagement features 20 are inserted in a generally downward direction. The lateral spacing between receptacles 24 is such that when engagement features 20 are fully and properly inserted, upper stiffeners 16 are held apart from one another such that the upper opening of carry bag 10 is of sufficient size to allow recharging cable 13 and/or associated components to be easily inserted and removed through the opening.

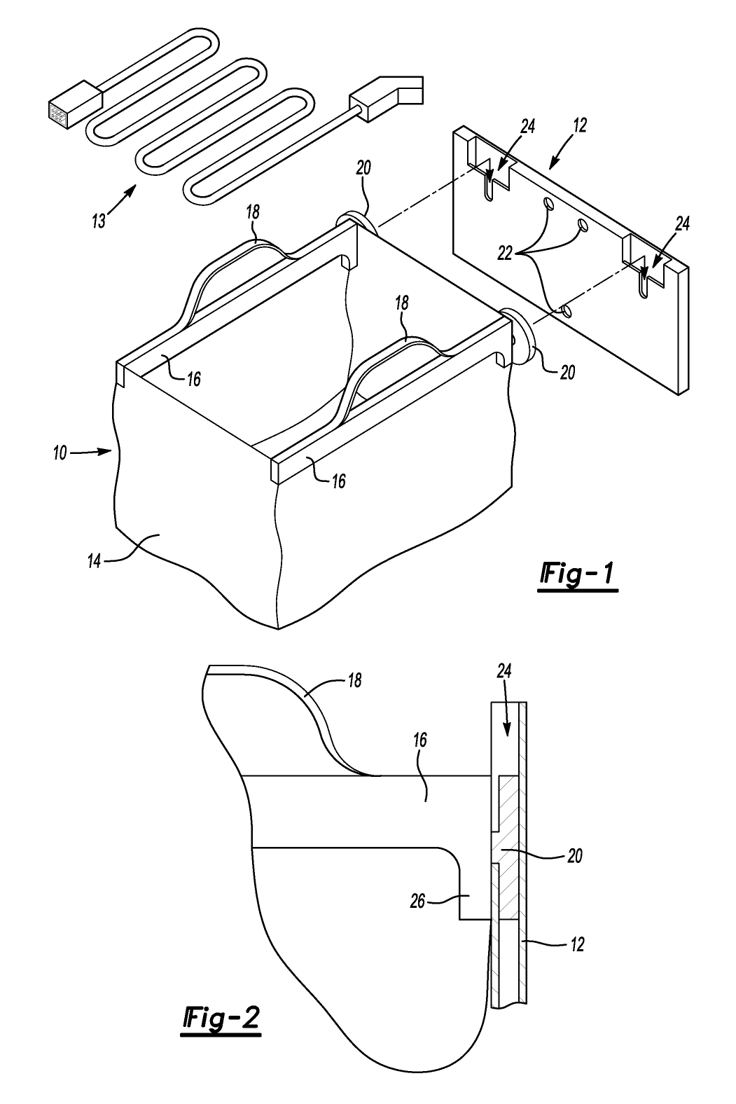

As best seen in FIG. 2, upper stiffeners 16 may comprise extensions 26 projecting generally perpendicular from the main portion of the stiffeners that extend along the edges of the upper opening. When engagement features 20 are inserted fully into receptacles 24, extensions 26 bear against the surface of mounting bracket 12 to provide a stabilizing effect and maintain the upper stiffeners 16 in a generally horizontal orientation within the vehicle interior. The term “generally horizontal” is meant to describe a position wherein the upper stiffeners 16 maintain the carry bag 10 so that its upper opening may be conveniently accessed by a person to place the charging cable 13 into and remove it from the bag. Depending upon the location of the carrier kit installation within the vehicle, this position may deviate as much as approximately plus or minus 45 degrees from horizontal. Further, some bending or sagging of upper stiffeners 16 from a purely horizontal condition may occur due to the weight of the cable and associated components.

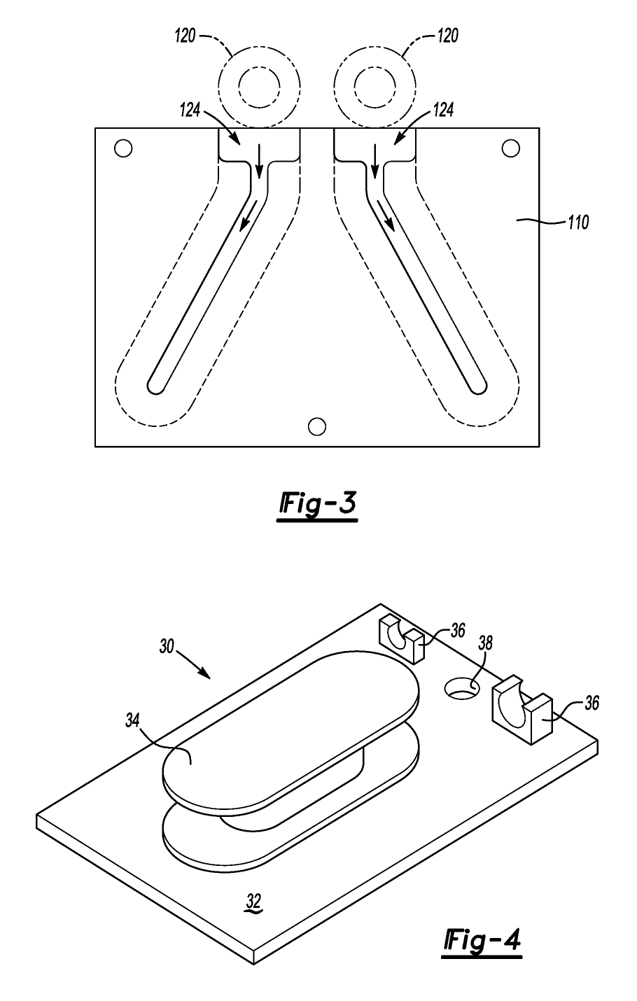

Referring now to FIG. 3, an alternative embodiment of a mounting bracket 112 is shown to include receptacles 124 that are positioned close together adjacent the upper end of the mounting bracket. This allows engagement features 120 to be easily inserted into their respective receptacles 124 when the upper stiffeners attached to the engagement features are close to one another, as will be the case when a person is grasping both handles of the carry bag 10 in one hand. After inserting engagement features 120 downward into receptacles 124, the handles are released and gravity pulls carry bag 10 downward and the engagement features 120 travel to the bottoms of receptacles, thus causing the upper stiffeners to move away from one another so that the carry bag assumes a fully open position.

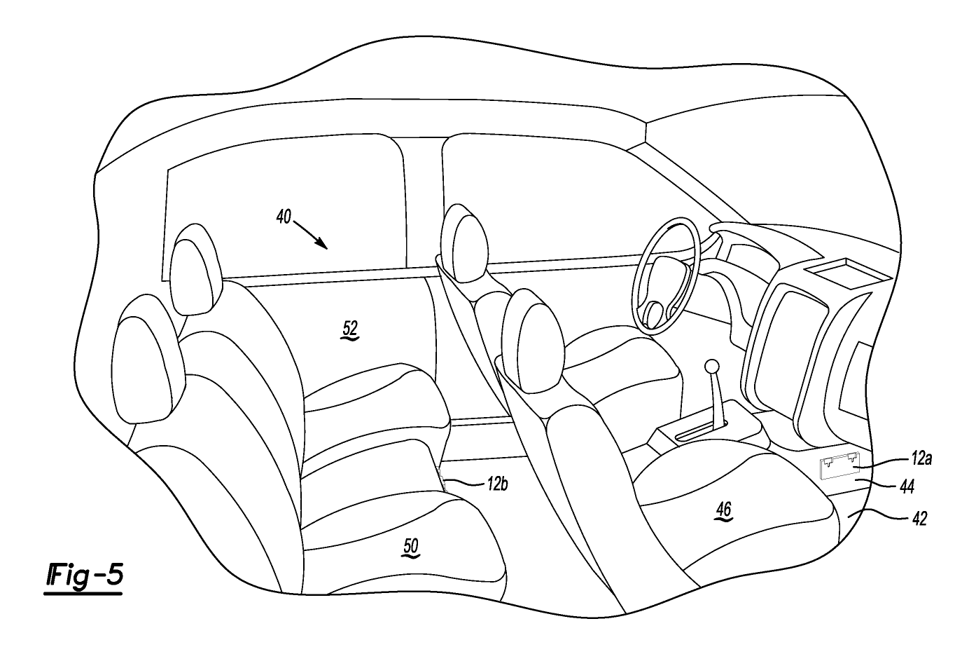

As seen in FIG. 4, a cable retainer 30 for use with a carry/storage bag comprises a base 32 and a cable spool 34 around which the charging cable 13 may be wrapped for storage and/or transport. Base 32 may advantageously be of the proper size to lay substantially flat in the bottom of cable compartment 14, and also to be easily inserted and withdrawn through the upper opening of the carry bag 10. Additional convenience features may be provided such as connector holders 36 which engage in the connectors or terminals at the ends of the charging cable. A hole 38 or other mounting feature(s) may also be provided to allow cable retainer 30 to hang on a wall or other support outside of the vehicle when the cable is not being stored in the vehicle.

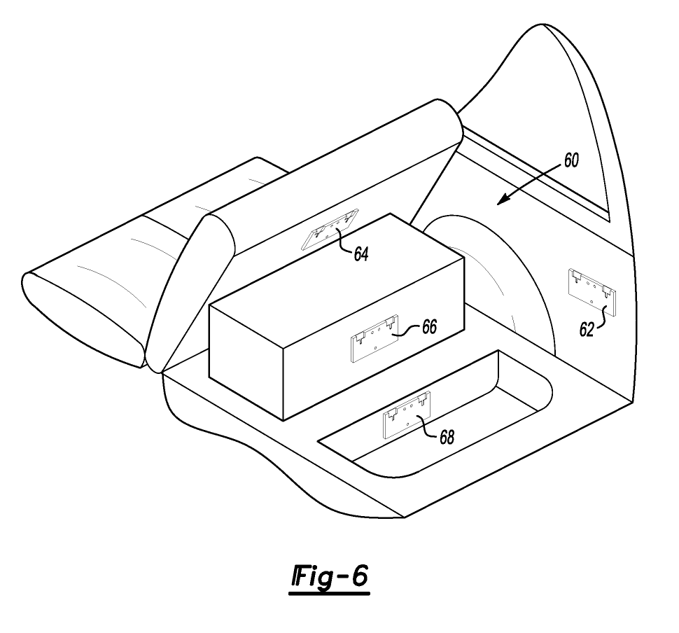

Referring now to FIG. 5, two examples of the multitude of possible alternative locations for a mounting bracket are shown within an interior 40 of a typical passenger vehicle. In a first possible location, a bracket 12a is secured or mounted to vehicle structure in or adjacent to a front passenger seat foot well area 42. Bracket 12a may be secured to the generally vertical side surface of front console 44, as shown, or it may be mounted to any other structure in the vicinity of the foot well 42, such as to the base or other structure associated with passenger seat 46.

In a second example of a possible a mounting location, bracket 12b is shown secured to a vehicle structure in the rear seating row 48 such as to the forward-facing surface near the center of a rear bench seat 50. This mounting location positions the carry bag 10 between the left and right seating locations and is easily accessible through either of the rear passenger doors 52 (only the left door depicted) to insert or withdraw the carry bag. Other possible locations for a mounting bracket in the rear seating row are on a rear-most surface of console 44 adjacent the rear seat foot well (not visible in FIG. 5).

FIG. 6 generally indicates several additional alternative locations for securing a mounting bracket and carry bag within a cargo compartment or trunk area 60 of a vehicle. Mounting locations may include on a lateral wall of the cargo compartment 62, on a rear surface of a seat back 64, on a rear facing surface of a battery compartment 66, and on any of the generally vertical surfaces forming a rear storage tub 68.

To provide a vehicle user the options and flexibility in locating the carry kit within the vehicle, it may be desirable to provide two or more mounting brackets at different locations within the passenger compartment and/or cargo compartment and/or trunk of the vehicle.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A battery charging kit for an automotive vehicle comprising:
a charging cable;
a mounting bracket attachable to a structure within an interior of the vehicle; and
a carry bag comprising at least one flexible panel and a rigid component attached to the flexible panel adjacent an upper opening of the bag, the rigid component comprising an engagement feature removably attachable to the mounting bracket to retain the carry bag such that the at least one flexible panel hangs downwardly from the at least one rigid component and the upper opening is in an open condition.

2. The apparatus of claim 1 wherein the rigid component comprises a first and a second engagement feature and the mounting bracket comprises a first retention point engageable with the first engagement feature and a second retention point engageable with the second engagement feature, the first and second retention points spaced apart from one another by a distance such that the upper opening is in the open condition when the engagement features are engaged with their respective retention points.

3. The apparatus of claim 2 wherein the rigid component comprises a first stiffener extending along a first upper edge of the bag and a second stiffener extending along a second upper edge of the bag, the first engagement feature being attached to an end of the first stiffener and the second engagement feature being attached to an end of the second stiffener, whereby engagement of the first and second engagement features with the respective retention points maintains the first and second stiffeners in a spaced apart relationship with one another to define opposite edges of the upper opening.

4. Apparatus according to claim 3 wherein the each of the first and the second stiffeners comprises a stabilizing extension that, when the stiffener is engaged with its respective retention point, contacts at least one of the mounting bracket and a vehicle structure below the mounting bracket to maintain the stiffener in an approximately horizontal position.

5. The apparatus of claim 1 further comprising a cable retainer configured to fit into the bag and to which the cable is secured for storage.

6. The apparatus of claim 5 further wherein the cable retainer comprises a plate configured to lay flush with an inner bottom surface of the bag and a cable spool extending from the base plate.

7. The apparatus of claim 1 further comprising:
a second mounting bracket attachable to a second structure within the interior of the vehicle, the carry bag being alternatively engageable with either of the mounting bracket and the second mounting bracket.

8. The apparatus of claim 1 further comprising:
a carry handle attached to the rigid component, the carry handle sized to be easily grasped by a human hand.

9. A battery charging kit for an automotive vehicle comprising:
a carry bag comprising first and second flexible side walls, a first stiffener extending along an upper edge of the first sidewall, a second stiffener extending along an upper edge of the second sidewall, and a carry handle; and
a mounting bracket securable at a location within an interior of the vehicle and comprising a first retention point for removably receiving the first stiffener and a second retention point for removably receiving the second stiffener, the first and second retention points spaced apart from one another by a distance such that the first and second stiffeners, when engaged with their respective retention points, are spaced apart from one another to define opposite edges of an opening of the carry bag, the opening being sufficiently large to receive a battery charging cable therethrough.

10. The apparatus of claim 9 further comprising:
a second mounting bracket secured at a second location within the interior of the vehicle, the carry bag being alternatively engageable with either of the mounting bracket and the second mounting bracket.

11. The apparatus of claim 9 wherein the first location is in a front seating row and the second location is in a rear seating row.

12. The apparatus of claim 9 wherein the first location is in one of a front seating row and a rear seating row, and the second location is in a cargo compartment.

13. Apparatus according to claim 9 wherein the each of the first and the second stiffeners comprises a stabilizing extension that, when the stiffener is engaged with its respective retention point, contacts at least one of the mounting bracket and a vehicle structure below the mounting bracket to maintain the stiffener in an approximately horizontal position.

14. The apparatus of claim 8 further comprising a cable retainer configured to fit into the carry bag and to which the cable is secured for compact storage.

15. The apparatus of claim 14 wherein the cable retainer comprises a plate configured to lay flush with an inner bottom surface of the carry bag and the cable spool extending from the base plate.

16. A charging cable carry bag for use with an automotive vehicle comprising:
at least one flexible panel;
a first stiffener attached to a first edge of the panel;
a second stiffener attached to a second edge of the panel;
a first engagement feature disposed at an end of the first stiffener; and
a second engagement feature dispensed at an end of the second stiffener, the first and second engagement features adapted to removably engage with respective first and second retention points disposed in an interior compartment of the vehicle and retain the carry bag such that the first and second stiffeners are spaced apart from one another to define opposite edges of an upper bag opening sufficiently large to receive a battery charging cable therethrough, and the at least one flexible panel hangs downwardly from the stiffeners.

17. The apparatus of claim 16 wherein each of the first and the second stiffeners comprises a stabilizing extension that, when the stiffener is engaged with its respective retention point, contacts at least one of a mounting bracket and a vehicle structure below the mounting bracket to maintain the stiffener in an approximately horizontal position.

18. The apparatus of claim 16 further comprising:
a first carry handle attached to the first stiffener; and
a second carry handle attached to the second stiffener, the first and second carry handles sized to be easily grasped by a human hand when the first and second stiffeners are adjacent one another such that the upper bag opening is closed.

19. The apparatus of claim 16 further comprising a cable retainer configured to fit into the carry bag and to which the cable is secured for compact storage.

20. The apparatus of claim 19 wherein the cable retainer comprises a plate configured to lay flush with an inner bottom surface of the carry bag and the cable spool extending from the base plate.
